(19) United States
(12) Patent Application Publication
(10) Pub. No.: US 2006/0197974 A1
(43) Pub. Date: Sep. 7, 2006

(54) SYSTEM AND METHOD FOR MONITORING FILES TO BE PRINTED

(75) Inventors: Cai-Yang Luo, Shenzhen (CN); Gao-Peng Hu, Shenzhen (CN); An-Feng Shen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/306,535

(22) Filed: Dec. 31, 2005

(30) Foreign Application Priority Data
Jan. 21, 2005 (TW) 94101771

(51) Int. Cl. G06K 15/00

(52) U.S. Cl. 358/1.14

(57) ABSTRACT

A system for monitoring files to be printed includes: one or more printers (10) for printing files; an information controlling console (12) for receiving printing information of a file, and converting the printing information into a particular format; a first server (13) linked with the information controlling console for receiving the printing information transmitted from the information controlling console, determining whether the printing information is secure, dividing the printing information into result data packets, and transmitting the result data packets to the information controlling console; a second server (14) linked with the printers and the information controlling console for monitoring the files to be printed according to the result data packets. A method for monitoring files to be printed is also disclosed.

### FIELD OF THE INVENTION

The present invention generally relates to systems and methods for monitoring files, and more particularly to a system and method for monitoring files to be printed.

### DESCRIPTION OF RELATED ART

A printer is a well-known office machine that can be connected to a computer and outputs a printed document or an image. Specifically, the printer receives documents or image data created and edited by the computer as print data, translates the print data into a print language which is appropriate for setting printing conditions, and outputs the print data on a piece of paper using a colored dye such as ink or toner. Printers are used accompanying with a computer to print various kinds of items such as letters, documents, images, etc. In certain computing environments, it is desirable to monitor information that relates to each print job. Monitoring information relating to each print job may be referred to herein as print job counting. Benefits may be realized by providing improved functionality to software used in printing and print job counting.

Current techniques for monitoring a print job are performed through an independent process. For example, in the Microsoft Windows family of operating systems, a printer monitor independently monitors the spooling of a print job. Generally, the printer monitor monitors the spooling processes. If the print job is locally despooled, as with a locally connected printer, or directly despooled to a remote printer, the progress of despooling the print data to the printing device is monitored. If the print job is remotely despooled, as with a print server, the progress of despooling a print job from the print server to the printing device is monitored. Although this technique is available, it does not monitor the process of the print job on the printing device.

Obviously, people are not satisfied with this stagnant technique. It is worse especially for printing a file going with many problems (for example: a size of the file to be printed is beyond the range of the capability of a printer), which are not monitored automatically. If the size of the file to be printed is beyond the range of the capability of the printer, the printer may be in a risk, and it is time consuming for a user to check the printer or he has to wait for the impossible operation.

What is needed, therefore, is a system and method which monitor files to be printed automatically.

### SUMMARY OF INVENTION

A system for monitoring files to be printed in accordance with a preferred embodiment includes one or more printers, an information controlling console, a first server linked with the information controlling console, a second server linked with the printers and the information controlling console. The printers are used for printing files. The information controlling console is used for receiving printing information of a file, and converting the printing information into a particular format. The first server is used for receiving the printing information transmitted from the information controlling console, determining whether the printing information is secure, dividing the printing information into result data packets, and transmitting the result data packets to the information controlling console. The second server is used for monitoring the files to be printed according to the result data packets.

A computer-based method for monitoring files to be printed in accordance with a preferred embodiment includes the steps of: capturing printing information of a file by a first server; transmitting the printing information from the first server to an information controlling console; converting the printing information into a particular format by the information controlling console, and transmitting the converted printing information to a second server; determining whether the printing information is secure; dividing the printing information into result data packets according to the comparing results, and transmitting the result data packets to the information controlling console; converting the result data packets into a particular format, and transmitting the result data packets to the first server; and processing the operation of printing the file if the printing information of the file is secure; or canceling the operation of printing the file if the printing information of the file is not secure.

Other advantages and novel features of the present invention will become more apparent from the following detailed description of preferred embodiments when taken in conjunction with the accompanying drawings, in which:

### BRIEF DESCRIPTION OF DRAWINGS

FIG. 1 is a schematic diagram of hardware configuration of a system for monitoring files to be printed in accordance with a preferred embodiment;

FIG. 2 is a schematic diagram of main function modules of the system of FIG. 1; and

FIG. 3 is a flowchart of a method for monitoring files to be printed in accordance with a preferred embodiment.

### DETAILED DESCRIPTION

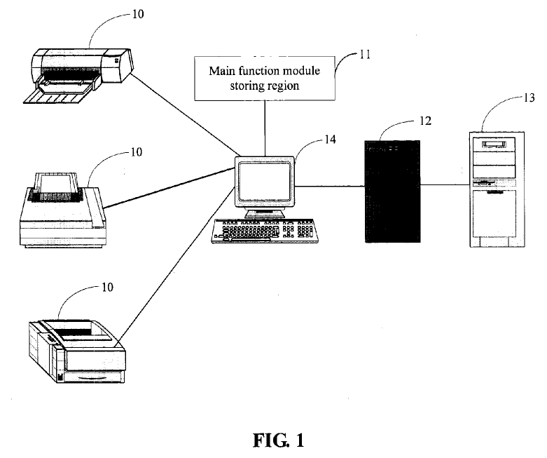

FIG. 1 is a schematic diagram of hardware configuration of a system for monitoring files to be printed (hereinafter, “the system”) in accordance with a preferred embodiment. The system includes: a plurality of printers 10 (only three shown), an information controlling console 12, a server 14 linked with the printers 10 and the information controlling console 12, and an information monitoring server 13 linked with the information controlling console 12. The server 14 includes a main function module storing region 11, and is further linked with one or more client computers (not shown).

The information monitoring server 13 stores file printing tactics, receives printing information transmitted from the information controlling console 12 and determines whether the printing information is secure according to the file printing tactics. The file printing tactics may include: a threshold of pages that can be printed during a time period, a threshold of time to print a file, a threshold of size of a file to be printed. If a file to be printed does not satisfy the file printing tactics described above, the server 14 cancels the printing of the file. For example, if one can print a file for 100 pages in 20 minutes, and he/she has printed the file for 60 pages in a certain time period, he/she can only print the file for less than 40 during a remaining time period according to the 20-minute restriction.

The information monitoring server 13 is further used for dividing the printing information into result data packets according to the file printing tactics, and transmitting the result data packets to the information controlling console 12. Contents of the result data packets include the printing information and a determination showing whether the printing information is secure or not according to the file printing tactics. Each result data packet corresponds to a file printing tactic.

The information controlling console 12 can be considered as a “bridge” when the information monitoring server 13 communicates with the server 14. In the preferred embodiment, the information controlling console 12 is used for receiving the printing information being monitored by the server 14, converting the printing information into a particular format which can be identified by the information monitoring server 13, and transmitting the converted printing information to the information monitoring server 13. The information controlling console 12 is also used for receiving the result data packets transmitted from the information monitoring server 13, converting the result data packets into a particular format which can be identified by the server 14, and transmitting the converted result data packets to the server 14.

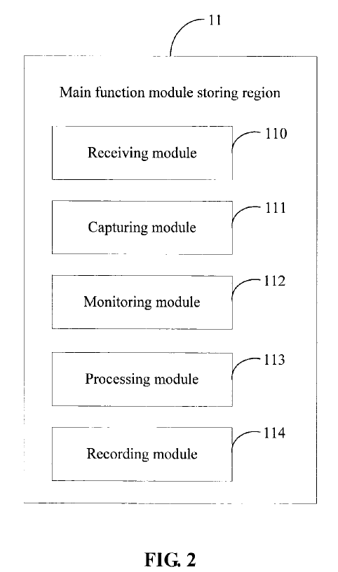

FIG. 2 is a schematic diagram of main function module storing region of the server 14. The main function module storing region 111 typically includes a receiving module 110, a capturing module 111, a monitoring module 112, a processing module 113, and a recording module 114.

The receiving module 110 is used for receiving data of printing options sent from a user through a client computer. When the user wants to print a file, he/she can set printing options of the file, which is a necessary operation before printing the file. The printing options typically includes: time to print the file, a paper type to be used (for example, A4 or B2), the number of pages to be printed (for example, printing all the pages of the file or printing only the current page). The data of printing options are sent to the server 14 if the user finishes setting corresponding printing options.

The capturing module 111 is used for capturing printing information of a file before the file is printed. The printing information typically includes: the number of pages to be printed, time to print the file, a size of the file, a paper type to be used, a title of the file, contents of the file and a type of the file.

The information monitoring server 13 determines whether the printing information received is secure by comparing the file printing tactics described above with the printing information of the file to be printed. For example, the printing information received is determined insecure if the size of the file is larger than the threshold of size of the file according to the file printing tactics.

The monitoring module 112 is used for receiving the printing information of the file to be printed, and transmitting the printing information to the information controlling console 12. Then, the information controlling console 12 transmits the printing information to the information monitoring server 13, in order to determine whether the printing information is secure.

The processing module 113 is used for receiving result data packets transmitted from the information controlling console 12, processing the operation of printing the file if the printing information of the file is secure, or canceling the operation of printing the file if the printing information of the file is not secure.

The recording module 114 is used for recording operation data when printing the file. The operation data typically include: a printer name, a user name, the threshold of pages that the user can print in a time period, pages that have been printed, the number of pages to be printed, time to print the file, a size of the file being printed, a paper type selected.

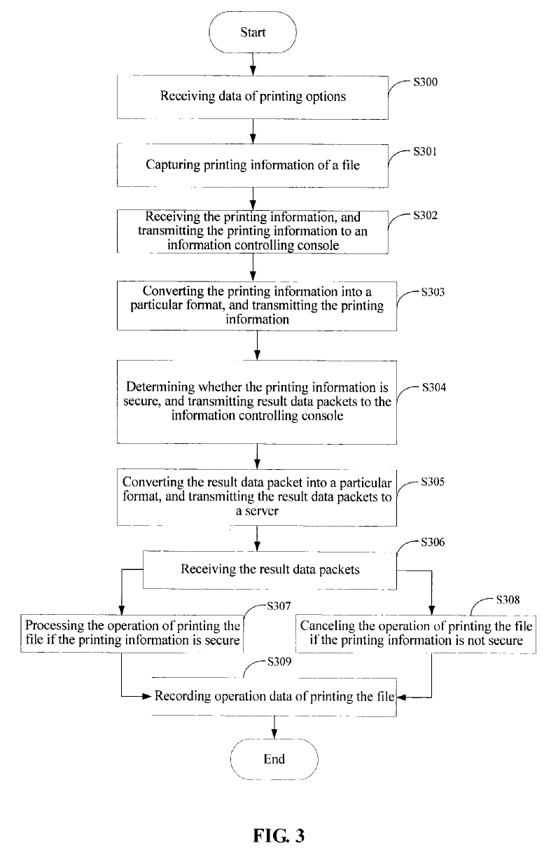

FIG. 3 is a flowchart of a method for monitoring files to be printed in accordance with a preferred embodiment. If a user wants to print a file, and he/she has sent data of printing options to any of the printers 10 through a client computer, in step S300, the server 14 activates the receiving module 110. The receiving module 110 receives the data of printing options. In step S301, the server 14 activates the capturing module 111. The capturing module 111 captures printing information of the file before the file is printed. In step S302, the server 14 activates the monitoring module 112. The monitoring module 112 receives the printing information of the file, and transmits the printing information to the information controlling console 12. In step S303, the information controlling console 12 converts the printing information into a particular format which can be identified by the information monitoring server 13, and transmits the printing information to the information monitoring server 13. In step S304, the information monitoring server 13 determines whether the printing information is secure by comparing corresponding file printing tactics stored in itself with the printing information, divides the printing information into result data packets corresponding to the comparing results, and transmits the result data packets to the information controlling console 12. In step S305, the information controlling console 12 converts the result data packets into a format which can be identified by the server 14, and transmits the result data packets to the server 14. In step S306, the server 14 activates the processing module 113. The processing module 113 receives the result data packets transmitted from the information controlling console 12. The contents of the result data packets include the printing information and a determination showing whether the printing information of the file is secure or not. If the printing information of the file is secure, in step S307, the processing module 113 processes the operation of printing the file. Otherwise, if the printing information of the file is not secure, in step S308, the processing module 113 cancels the operation of printing the file. In step S309, the server 14 activates the recording module 114. The recording module 114 records the operation data of printing the file.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for monitoring files to be printed, the system comprising:
one or more printers for printing files;
an information controlling console for receiving printing information of a file, and converting the printing information into a particular format;
a first server linked with the information controlling console for receiving the printing information transmitted from the information controlling console, determining whether the printing information is secure, dividing the printing information into result data packets, and transmitting the result data packets to the information controlling console; and
a second server linked with the printers and the information controlling console for monitoring the files to be printed according to the result data packets.

2. The system as claimed in claim 1, wherein the information controlling console is further used for converting the result data packets into a particular format and transmitting the result data packets to the second server.

3. The system as claimed in claim 1, wherein the second server comprises:
a capturing module for capturing the printing information of the file before the file is printed;
a monitoring module for receiving the printing information, and transmitting the printing information to the information controlling console;
a processing module for receiving the result data packets transmitted from the information controlling console, processing an operation of printing the file if the printing information of the file is secure, or canceling the operation of printing the file if the printing information of the file is not secure; and
a recording module for recording operation data of printing the file.

4. The system as claimed in claim 1, wherein the first server stores file printing tactics.

5. The system as claimed in claim 4, wherein the first server determines whether the printing information is secure by comparing the file printing tactics with the printing information.

6. A computer-based method for monitoring files to be printed, the method comprising the steps of:
capturing printing information of a file by a first server;
transmitting the printing information from the first server to an information controlling console;
converting the printing information into a particular format by the information controlling console, and transmitting the converted printing information to a second server;
determining whether the printing information is secure;
dividing the printing information into result data packets according to the comparing results, and transmitting the result data packets to the information controlling console;
converting the result data packets into a particular format, and transmitting the result data packets to the first server; and
processing the operation of printing the file if the printing information of the file is secure; or
canceling the operation of printing the file if the printing information of the file is not secure.

7. The method as claimed in claim 6, further comprising the step of recording operation data of printing the file.
